(19) United States
(12) Patent Application Publication
(10) Pub. No.: US 2004/0235378 A1
(43) Pub. Date: Nov. 25, 2004

(54) Vehicle interior trim component of basalt fibers and thermosetting resin and method of manufacturing the same

(76) Inventors: George B. Byma, Clarkston, MI (US); Brian A. Cristea, Royal Oak, MI (US)

Correspondence Address: MACMILLAN, SOBANSKI & TODD, LLC, ONE MARITIME PLAZA-FOURTH FLOOR, 720 WATER STREET, TOLEDO, OH, 43604, US

(21) Appl. No.: 10/440,889

(22) Filed: May 19, 2003

(51) Int. Cl. B32B 27/12; B32B 27/02; B32B 27/04

(52) U.S. Cl. 442/43; 442/30; 442/45; 442/46; 442/49; 442/149

(57) ABSTRACT

A laminate for use as a headliner comprises a core having an adhesive layer provided adjacent opposing sides thereof. Basalt fiber structural reinforcement layers are provided adjacent each adhesive layer. A scrim layer is provided next to one reinforcement layer while a film barrier and covering are provided adjacent the other reinforcement layer. A method for manufacturing the laminate comprises the steps of providing a core, providing basalt fiber reinforcement layers adjacent opposing sides of the core, providing adhesive layers between opposing sides of the core and the reinforcement layers, applying a scrim layer to one reinforcement layer and a film barrier and covering to the other reinforcement layer to complete the laminate. According to a method for recycling a laminate, laminate material formed of composite materials including reinforcement fibers that have a melting point above the incineration point of the other composite materials is provided. The laminate is heated to a temperature below the melting point of the basalt and above the incineration point of the other composite materials to reduce the other composite materials to ash without melting the basalt.

### BACKGROUND OF INVENTION

The present invention pertains generally to molding of composite materials, including fibers and plastics and, more particularly, to molding of structural and acoustical panels, which include basalt fibers and thermosetting resins.

Composite material panels are used in many different applications, including automobiles, airplanes, trains, and housing and building construction. The properties sought in such panels are strength, rigidity, sound absorption, and heat and moisture resistance. One application of such panels that has been especially challenging is with automobile headliners and other automotive interior panels. Many different types of laminates and laminated composites have been tested and produced for use in automobiles.

Some headliners have a core of glass fibers and a polyester resin. Others have a core of open cell polyurethane foam impregnated with a thermosetting resin and a reinforcing layer of fiberglass. Still others have a first fiber-reinforcing mat, such as a glass fiber mat, on one side of a fibrous core and a second fiber-reinforcing mat on the opposite side to form a laminate. The exposed surfaces of the reinforcing mats are then coated with a resin and an outer covering is applied. The composite or laminate is ultimately formed to a desired shape under heat and pressure (i.e., compression molding) and cut to a desired size by a trimmer.

Although manufacturers strive to minimize the amount of material that is removed from the headliner when trimmed, material is still removed. It is desirable, and sometimes required, that the material removed be recycled as well as end of life for the part. One method of recycling that is gaining popularity involves incineration and reclamation of the energy resulting from the incineration.

Regardless of the method of construction, headliners containing glass fibers shorten the life of the furnace used for recycling. This occurs because the furnace must be heated to a temperature that exceeds the melting point of the glass in order to reduce the other composite materials to ash. The melted glass coats the furnace and solidifies when cooled. The solid glass is difficult to remove from the incinerator walls. What is needed is a headliner composition that meets its functional requirements while, at the same time, is more suitable for recycling.

### SUMMARY OF INVENTION

The present invention is directed toward a headliner that meets the foregoing needs. More particularly, the invention is directed toward a laminate for use as a headliner. The laminate comprises a core having an adhesive layers adjacent opposing sides thereof. A basalt fiber structural reinforcement layer is provided adjacent each adhesive layer. A scrim layer is provided next to one reinforcement layer while a film barrier and covering are provided adjacent the other reinforcement layer.

The invention is also directed toward a method for manufacturing a laminate. The method comprises the steps of providing a core, providing basalt fiber reinforcement layers adjacent opposing sides of the core, providing adhesive layers between opposing sides of the core and the reinforcement layers, applying a scrim layer to one reinforcement layer and a film barrier and covering to the other reinforcement layer to complete the laminate.

The invention is further directed toward a method for recycling laminate material. The method comprises the steps of providing a laminate material formed of composite materials including reinforcement fibers that have a melting point above the incineration point of the other composite materials and heating the laminate to a temperature below the melting point of the basalt and above the incineration point of the other composite materials to reduce the other composite materials to ash without melting the basalt.

Various objects and advantages of this invention will become apparent to those skilled in the art from the following detailed description of the preferred embodiment, when read in light of the accompanying drawings.

### BRIEF DESCRIPTION OF DRAWINGS

FIG. 1 is a schematic representation of the laminated structure according to a preferred embodiment of the invention; and

FIG. 2 is a schematic representation of a manufacturing set-up for producing the laminated structure shown in FIG. 1 in accordance with a method of manufacture according to a preferred embodiment of the invention.

### DETAILED DESCRIPTION

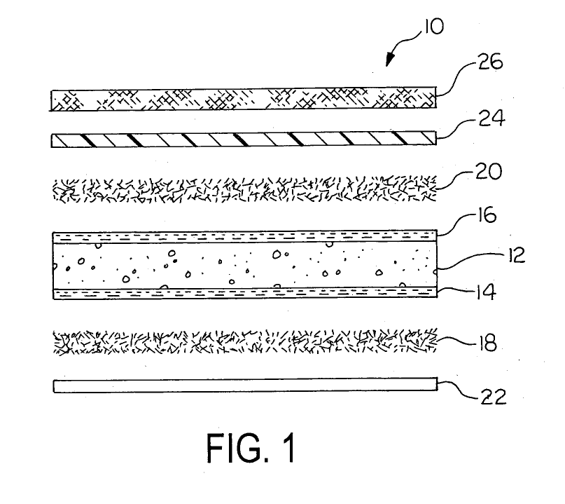

Now with reference to the drawings, wherein like numerals designate like components throughout all of the several figures, there is schematically represented in FIG. 1 a laminate, collectively referenced at 10, according to a preferred embodiment of the invention, for use as a headliner for an automobile. The laminate 10 is made up of combined materials including a core 12. A layer of adhesive 14, 16, preferably a liquid adhesive layer, is applied to opposing sides of the core 12 (i.e., above and below the core 10 when viewing FIG. 1). Structural reinforcement layers 18, 20 are provided on each side to the core 12, each adjacent a corresponding layer of liquid adhesive 14, 16. A scrim 22 is provided adjacent one side of the core 12 (i.e., at the bottom of the laminate 10 when viewing FIG. 1) next to a corresponding reinforcement layer 18. A film barrier 24 and covering 26 are provided adjacent the other side of the core 12 (i.e., atop the laminate 10 when viewing FIG. 1) next to a corresponding reinforcement layer 20.

It should be appreciated the adhesive layers 14, 16 need not be applied to the core 12 but instead may be applied to the structural reinforcement layers 18, 20, or to both the core 12 and the structural reinforcement layers 18, 20. It should also be appreciated that the adhesive layers 14, 16 is not intended to be limited to liquid but may be any adhesive suitable for carrying out the invention.

The core 12 is most preferably made of polyurethane resin (PUR) foam due to its light weight, compression resistance, moldability, acoustic absorption, and ability to allow engineered solutions to automotive overhead systems problems. The core 12 may vary in thickness and density and internal load deflection (ILD). For example, the core 12 may have a thickness in a range from about 2 mm to about 30 mm and a density in a range from about 1.0 lb/ft³ to about 3.5 lb/ft³. The composition, thickness, and density of the core 12 depend upon depth of draw (i.e., the vertical dimension that the laminate 10 will deviate from a flat horizontal plane), acoustical requirements, and load bearing requirements. It should be understood that the aforementioned core compositions and thickness and density ranges are given as examples and that the invention is not limited to such compositions or ranges.

The adhesive layers 14, 16 are preferably in the form of an elastomeric thermosetting liquid resin, such as polyurethane adhesive. One preferred adhesive is Forbo 2U010/22014, manufactured by Forbo Adhesives, LLC, of Research Triangle Park, N.C. The weight of the adhesive layers 14, 16 may be in a range from about 20 g/m² to about 200 g/m² and is most preferably about 35 g/m² to about 50 g/m² to wet out the reinforcing fibers and achieve bonds to the adjacent material layers. The adhesive layers 14, 16 may be applied by a conventional roll coating process, or any other suitable coating process for applying to the adhesive layers 14, 16 to the surface of the core 12. As stated above, the adhesive layers 14, 16 may alternatively be applied to the reinforcement layers 18, 20, or to both the core 12 and the reinforcement layers 18, 20. Although some surface saturation may occur, the core 12 is not impregnated with liquid adhesive. This is because the primary function of the adhesive is to bond the reinforcing fibers to the core 12 and this occurs on the surface. The adhesive layers 14, 16, when heated, in the presence of catalyst, react to form a thermoset. This catalyzed reaction causes the adhesive to cure and the laminated structure to become rigid. It should be understood that the aforementioned adhesive layer weights are given as examples and that the invention is not limited to such weights.

The structural reinforcement layers 18, 20 are preferably fibers and most particularly basalt fibers. The fibers may be continuous or chopped and may be coated with a sizing treatment, which makes the fibers highly compatible with the thermosetting liquid resin. The fibers may be allowed to fall randomly to opposing sides of the core 12, adjacent corresponding adhesive layers 14, 16. The structural reinforcement layers 18, 20 preferably have a weight in a range from about 20 g/m² to about 200 g/m² to create a composite of appropriate strength and stiffness to support the OEM requirement, although other weights may be suitable for carrying out the invention. The basalt fibers have a high tensile strength. The tensile strength of basalt fibers compared to E-glass fibers shows the basalt to be superior (i.e., 4840 Mpa for basalt versus 3450 Mpa for E-glass). The melting point of basalt fibers is higher than that of E-glass fibers. This-makes basalt superior to glass in terms of recycling (e.g., recycling by incineration) and energy reclamation and tensile strength, as will become more apparent in the description that follows.

The scrim layer 22 is preferably made of a lightweight polymer or plastic, such as polyethylene terephthalate (PET), nylon, or blends thereof. The scrim layer 22 may be a woven, non-woven, or film backing or barrier. Moreover, the scrim layer 22 may be a bi-laminate formed of a scrim and a barrier. The melting point of the scrim layer 22 is preferably higher than the forming die temperature so that the scrim layer 22 does not stick to the die. The scrim layer 22 may function to retain the resin within the laminate 10 and thereby prevent the thermosetting resin from reaching the forming die of a mold, as will become apparent in the description that follows. Hence, the scrim layer 22 may aid in releasing the laminate 10 from the forming die. This works for plastic scrims as long as the melting point is above the forming die temperature, as stated above. The scrim layer 22 may also be used to bond with and add strength or provide additional rigidity to the adjacent reinforcement layer 18, assist in holding the adjacent reinforcement layer 18 together, and/or have shape-retention properties. Furthermore, the scrim layer 22 preferably provides a finished surface for mounting against the roof of an automobile and prevents or reduces vibration or abrasion noise when in contact with the roof.

The film barrier 24 is made of thermoplastic. The film barrier 24 is preferably substantially imperforate. In addition, the film barrier 24 preferably has a great affinity for the covering 26 and the basalt fiber layer 20 so that the layers above and below the film barrier 24 readily adhere to the film barrier 24. Furthermore, the film barrier 24 may provide a barrier against the adhesive layer 16 from bleeding into or through covering 26, causing permanent surface imperfections, and reaching the forming die.

The covering 26 is applied over the film barrier 24 to complete the laminate 10. The covering 26 is preferably made of fabric or cloth (e.g., a headliner fabric), which may be a woven or non-woven textile with a polymer base, such as nylon or polyester. Alternatively, the covering 26 may be made of vinyl, leather, or the like. The covering 26 may be decorative to provide aesthetically pleasing finished surface and preferably has a flexible character, which includes sufficient stretch characteristics to allow the covering to match the design surface of the headliner. If a soft feel to the covering 26 is desired, the covering 26 may include a substrate in the form of polyether or polyester polyurethane foam (not shown), as is commonly known to one skilled in the art. The foam may also function as an acoustical absorption material.

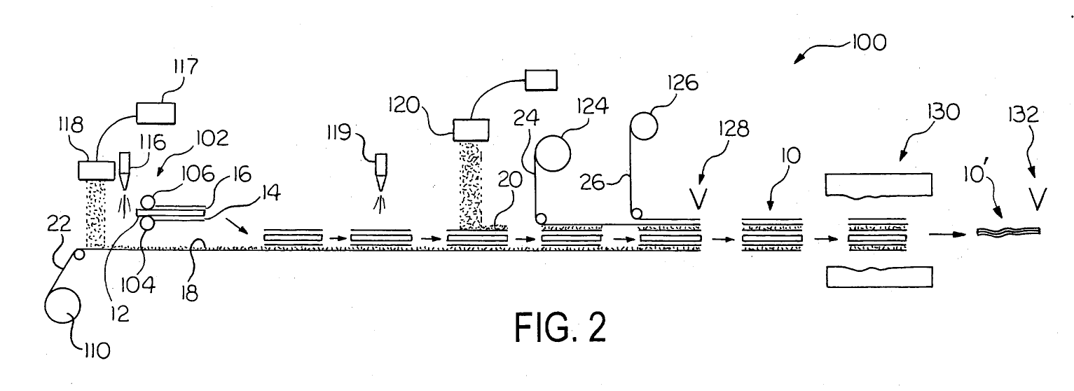

A method of manufacturing the laminate 10 is described with reference to FIG. 2. In an assembly line set-up indicated generally at 100, the core 12 is fed from a stack of blanks (not shown) through a liquid adhesive applicator, generally indicated at 102, at which the adhesive layers 14, 16 are applied to the opposing sides of the core 12 (i.e., the upper and lower sides of the core 12 when viewing FIG. 2). The liquid adhesive applicator 102 may be in the form of a roll coat system comprising upper and lower rollers 104, 106 continuously coated with liquid adhesive supplied from reservoirs or dispensers (not shown). Alternatively, the liquid adhesive may be applied by a knife-over-roller, a curtain, or a spray (not shown). Other applicators could likely be used but may be more complicated. In the former applicators, the adhesive should be applied at a rate sufficient to maintain a small layer of adhesive on the rollers, knife, or curtain to evenly coat the core 12. According to a preferred embodiment of the invention, the adhesive should be applied only to the surface of the core 12 with minimal surface penetration. As stated above, the adhesive layers 14, 16 may alternatively be applied to the reinforcement layers 18, 20, or to both the core 12 and the reinforcement layers 18, 20. It should be appreciated that the core 12 may be continuously fed rather than discretely fed in the form of blanks.

The core 12 with the adhesive layers 14, 16 applied thereto is then conveyed onto the scrim layer 22 carrying a structural reinforcement layer 18 (i.e., on the upper surface of the scrim layer 22 when viewing FIG. 2). The scrim layer 22 may be guided from a spool 110 by a guide roller and fed under a fiber source 118 for random distribution of fibers. The core 12 is fed at the same rate as the scrim layer 22. The fiber source is preferably basalt fiber strands or rovings. The fiber strands or rovings may be supplied from reservoir 117 and randomly applied to the scrim layer 22, preferably in a random gravity-fed fashion, such as by sprinkling fibers thereof from an agitator tray or chopper 118 positioned over the scrim layer 22, prior to conveying the core 12 onto the scrim layer 22. It should be appreciated that the fibers may be applied by manual distribution from a container or cut from continuous strands or rovings directly above the scrim layer 22 and allowed to fall randomly upon the scrim layer 22. It should further be understood that the structural reinforcement layer 18 may be a continuous prefabricated mat pulled from a spool (not shown) and applied to the scrim layer 22 as opposed to being chopped and distributed directly onto the scrim layer 22, as stated above. The structural reinforcement layer 18 may then pass a catalyst applicator 116, at which a catalyst (i.e., Forbo 22014 for accelerating the cure of the polyurethane liquid adhesive) may be sprayed onto the structural reinforcement layer 18.

The adhesive-coated core 12 may then pass a catalyst applicator 119, at which a catalyst (i.e., Forbo 22014) may be sprayed onto an exposed side of the core 12 (i.e., an upper side of the core when viewing FIG. 2) and the adhesive layer 16 thereon. Thereafter, the core 12 is passed under another chopper 120, which chops more basalt fibers, and randomly deposits those chopped fibers, as the other structural reinforcement layer 20, onto the exposed side of the core 12 adjacent the exposed, catalyzed, adhesive layer 16. The fibers are oriented to the plane of the core 12 at an infinite number of angles. As stated above, the structural reinforcement layer 20 may be a continuous prefabricated mat pulled from a spool (not shown) as opposed to being chopped and distributed directly deposited.

The film barrier 24 and the covering 26 are guided from spools 124, 126 onto the exposed structural reinforcement layer 20 to complete the laminate 10. The laminate 10 passes though a cutter 128, where it is cut to a desired length.

The laminate 10 is then conveyed to a mold 130. As is known in the art, the mold 130 is heated to a temperature sufficient to cure the liquid adhesive and bind it to the sizing on the fibers and sufficient to melt the film barrier 24. Pressure is applied to compress the laminate 10 to conform to the internal configuration of the mold 130. The molded laminate 10′ may then be cut as desired, for example, to form a completed headliner, by final trimmer 132, which is well known in the art.

One principle advantage of the invention is with regard to recycling material removed from the laminate 10 by the final trimmer 132, as well as end of life headliner laminates 10. Since the laminate 10 according to the present invention includes reinforcing fibers (e.g., basalt fibers) that have a higher melting point than the other composite materials, the laminate 10 and trimmings therefrom may be incinerated and energy resulting therefrom may be reclaimed, thus achieving desired or required recycling efforts. The composite materials of the laminate 10, but for the basalt fibers, are reduced to ash. The basalt fibers do not melt, if the incinerator temperature is controlled, and thus do not coat the incinerator. The ash and basalt fibers can easily be removed from the incinerator. Since the incinerator is not covered with molten fibers, as is the case with glass fibers, the life of the incinerator is prolonged.

Hence, the invention further includes a method of recycling laminate materials including one or more fiber layers, wherein the fibers are basalt fibers having a higher melting point than the other composite materials and the other composite materials are reduced to ash without reducing the fibers to a molten state.

The principle and mode of operation of this invention have been explained and illustrated in its preferred embodiment. However, it must be understood that this invention may be practiced otherwise than as specifically explained and illustrated without departing from its spirit or scope.

What is claimed is:

1. A laminate for use as a headliner for an automobile, the laminate comprising:
a core having opposing sides;
a layer of adhesive adjacent said opposing sides of said core;
a structural reinforcement layer adjacent each layer of adhesive, opposite said core, said structural reinforcement layers being basalt fibers;
a scrim layer adjacent one of said reinforcement layers; and
a film barrier and a covering adjacent the other one of said reinforcement layers.

2. The laminate of claim 1, wherein said core is made of a polyurethane resin foam.

3. The laminate of claim 1, wherein said adhesive layers are liquid.

4. The laminate of claim 1, wherein said adhesive layers are in the form of an elastomeric thermosetting liquid resin.

5. The laminate of claim 1, wherein said adhesive layers are in the form of a polyurethane adhesive.

6. The laminate of claim 1, wherein said adhesive layers are applied to surfaces of said core without substantial surface saturation.

7. The laminate of claim 1, wherein said scrim layer is made of a lightweight polymer film.

8. A method for manufacturing a laminate, comprising the steps of:
a) providing a core having opposing sides;
b) providing a structural reinforcement layer adjacent one of said opposing sides of said core, said structural reinforcement layers being basalt fiber layers;
c) providing an adhesive layer between said core and each one of said structural reinforcement layers;
d) providing a scrim carrying a first one of said structural reinforcement layers; and
e) providing a film barrier and a covering on a second one of said structural reinforcement layers to complete said laminate.

9. The method of claim 8, wherein, in step c), the adhesive layers are coatings applied to opposing sides of the core.

10. The method of claim 9, wherein, in step b), the basalt fibers are applied to the scrim layer to form the first structural reinforcement layer and deposited atop the coated core to form the second structural reinforcement layer.

11. The method of claim 10, wherein structural reinforcement layers are basalt fiber mats.

12. The method of claim 10, wherein structural reinforcement layers are chopped basalt fibers applied to the scrim layer and chopped fibers deposited on the coated core.

13. The method of claim 8, wherein said core is made of a polyurethane resin foam.

14. The method of claim 8, wherein said adhesive layers are liquid adhesive layers.

15. The method of claim 8, wherein said adhesive layers are in the form of an elastomeric thermosetting liquid resin.

16. The method of claim 8, wherein said adhesive layers are in the form of a polyurethane adhesive.

17. The method of claim 8, wherein the adhesive layers are applied at a rate sufficient to evenly coat the core with minimal surface penetration.

18. A method for recycling laminate material, comprising the steps of:
a) providing a laminate material formed of composite materials including reinforcement fibers that have a higher melting point than the other composite materials; and
b) heating the laminate to a temperature below the melting point of the basalt and above the incineration point of the other composite materials to reduce the other composite materials to ash.

19. The method of claim 18, wherein energy resulting from step b) is reclaimed to achieve a recycling effort.

20. The method of claim 18, wherein step b) further comprised the steps of placing the laminate in an incinerator prior to heating the laminate and then removing the ash and basalt fibers from the incinerator after heating the laminate.

21. The method of claim 18, wherein reinforcement fibers are entirely basalt.
